(19) United States
(12) Patent Application Publication
(10) Pub. No.: US 2010/0025444 A1
(43) Pub. Date: Feb. 4, 2010

(54) Hands-Free Viewing Assemblies for Portable Media Players

(76) Inventors: William Rodney Tipton, Acampo, CA (US); Marshall Tipton, Portland, OR (US); Randall Tipton, Portland, OR (US)

Correspondence Address: BAUMGARTNER PATENT LAW, 5933 N.E. WIN SIVERS DR. SUITE 250, PORTLAND, OR, 97220, US

(21) Appl. No.: 12/184,176

(22) Filed: Jul. 31, 2008

(51) Int. Cl. A45F 5/00; F16M 11/00

(52) U.S. Cl. 224/576; 248/682; 248/689

(57) ABSTRACT

Viewing assemblies are configured to hold and support a portable media player (PMP) and allow a user to view the PMP screen hands-free. Hands-free viewing assemblies can be user-supported and configured to be worn around a user's neck area or free-standing and configured to be placed on a solid surface.

### FIELD OF THE INVENTION

The embodiments herein relate to hands-free viewing assemblies for use with portable media players (PMPs), non-exclusively including: smart phones, handheld game consoles, and digital audio and video players capable of storing and playing files in one or more media formats. More specific embodiments relate to hands-free viewing assemblies that can interchangeably function as free-standing supports on a solid surface or as a user-supported frame.

### BACKGROUND

Because of the bulkiness of portable DVD players and the potential to lose or damage the accompanying DVDs, many people have begun to watch video and images on PMPs, such as iPods (e.g., iPod Touch), iPhones, and Zunes, for example. Many PMPs now allow a user to engage in multiple forms of entertainment including watching videos, playing games, or looking at images, for example. While less cumbersome to use than portable DVD players, PMPs in general have smaller screens for viewing. Accordingly, many users use their hands to bring the PMP's screen closer to their eyes. While holding the PMP in their hands briefly may not be problematic, it can be tiresome for the user to maintain this position for extended periods of time.

Accordingly, there is a need in the art to provide hands-free viewing assemblies that allow a user to view a PMP in a comfortable position. Furthermore, there is a need for PMP assemblies that can interchangeably function as a free-standing support or a user-based support. Additionally, there is a need for hands-free assemblies that allow the user to view their PMP in multiple positions, including portrait and landscape orientations.

### SUMMARY OF THE INVENTION

Preferred embodiments are directed to an assembly for allowing hands-free viewing of a portable media player having a screen and comprising a yoke comprising a backing configured to wrap around a user's neck area and coupled to first and second arms that are adapted to individually extend away from said backing on the user's left and right side of the neck respectively; a frame comprising means for coupling to the first and second arms of the yoke; and a cradle coupled to and supported by said frame and comprising means for releasably holding the portable media player in a position that allows said user to view the screen.

Further embodiments include assemblies where the yoke is also configured to function as a base to support said assembly on a solid surface. Preferably, the frame's means for coupling to said first and second arms of the yoke are joints configured such that the user can adjust the angle between the frame and the yoke. More specifically, the joints can be configured to allow the frame and yoke to collapse upon each other, or substantially so.

Preferred embodiments include assemblies where the means for holding the portable media player comprise two or three clamping members configured to compress the sides of a portable media player. Advantageous clamping members can include means for adjusting the distance from each other such that they can securely hold different sized portable media players. Cradles can be coupled to the frame by an extension member, such as a telescoping member or other means. Preferably, the cradle is configured to rotate around the y-axis of the extension member.

Further embodiments are directed to assemblies for allowing hands-free viewing of a portable media player having a screen and comprising a base configured to support said assembly and portable media player on a solid surface; a frame comprising first and second frame members, each having back and front ends, wherein the back ends of the first and second frame members comprises means for coupling to said base; and a cradle coupled to and supported by the front ends of the first and second frame members and comprising means for releasably holding the portable media player to allow said user to view the screen.

Preferred embodiments are directed to assemblies wherein said means for coupling to the base are joints configured such that the user can adjust the angle between the frame and the yoke. Preferred means for releasably holding the portable media player comprise two clamping members configured to compress the sides of a portable media player.

According to certain embodiments, the clamping members can include means for adjusting the distance from each other such that they can securely hold different sized portable media player. Preferably, the cradle is coupled to the frame by an extension member, such as a telescoping member.

Further embodiments are directed to assemblies that allow hands-free viewing of a portable media player having a screen and comprising a yoke comprising a backing configured to wrap around a user's neck area and coupled to first and second arms that are adapted to individually extend away from said backing on the user's left and right side of the neck respectively a frame comprising first and second frame members, each having back and front ends, wherein the back end of the first frame member comprises means for adjustably coupling to said first arm and the back end of the second frame member comprises means for adjustably coupling to said second arm an extension member supported by said front ends of the frame members; and a cradle coupled to and supported by said extension member and comprising means for releasably holding the portable media player in a plurality of positions to allow the user to view the screen.

Preferred means for holding the portable media player a plurality of positions are configured to allow for rotation of the cradle around the z-axis of the extension member. Further embodiments include means for holding the portable media player in a plurality of positions are configured to allow for rotation of the cradle around the y-axis of the extension member.

### BRIEF DESCRIPTION OF THE DRAWINGS

It will be appreciated that the drawings are not necessarily to scale, with emphasis instead being placed on illustrating the various aspects and features of embodiments of the invention, in which:

FIG. 1 is a perspective view of an assembly in a free-standing configuration.

FIG. 2 is a perspective view of an assembly in a user-supported configuration.

FIG. 3 is a perspective view of a user wearing an assembly in a user-supported configuration.

FIG. 4 is a close-up view showing the expansion of a cradle's clamping members.

FIG. 5 is a close-up view showing means for adjusting a cradle's height.

FIG. 6 is a close-up view showing means for rotating a cradle around its stem.

FIG. 7 is a close-up exploded view of a preferred joint that connects the frame to the yoke.

FIG. 8 is a close-up exploded view of a preferred frame connecting to an extension member that is in operable connection with a cradle.

FIG. 9 is an exploded view of a preferred three-member cradle for releasably holding a PMP and connecting to an extension member.

FIG. 10 is a perspective view of the back of a preferred three-member cradle for releasably holding a PMP and its telescoping extension member.

FIG. 11 is a perspective view of the front of a preferred three-member cradle for releasably holding a PMP and its telescoping extension member.

FIG. 12 is a perspective view of the back of a preferred three-member cradle holding a PMP.

### DETAILED DESCRIPTION OF THE ILLUSTRATED EMBODIMENTS

Embodiments of the present invention are described below. It is, however, expressly noted that the present invention is not limited to these embodiments, but rather the intention is that modifications that are apparent to the person skilled in the art and equivalents thereof are also included.

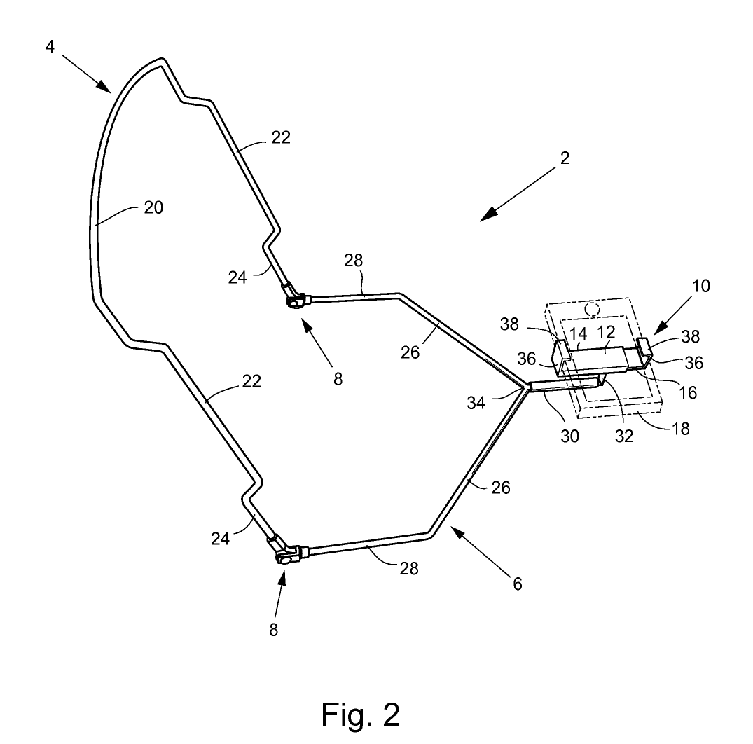

With reference to FIGS. 2 and 3, advantageous assemblies 2 herein function as a user-based support to allow personal viewing of a PMP 18. The term “PMP” generally relates to small electronic devices having screens and non-exclusively includes: smart phones, handheld game consoles, and digital audio and video players capable of storing and playing files in one or more media formats. According to preferred embodiments, the PMPs suitable to be used with the teachings herein are otherwise designed to be utilized in a user's hands.

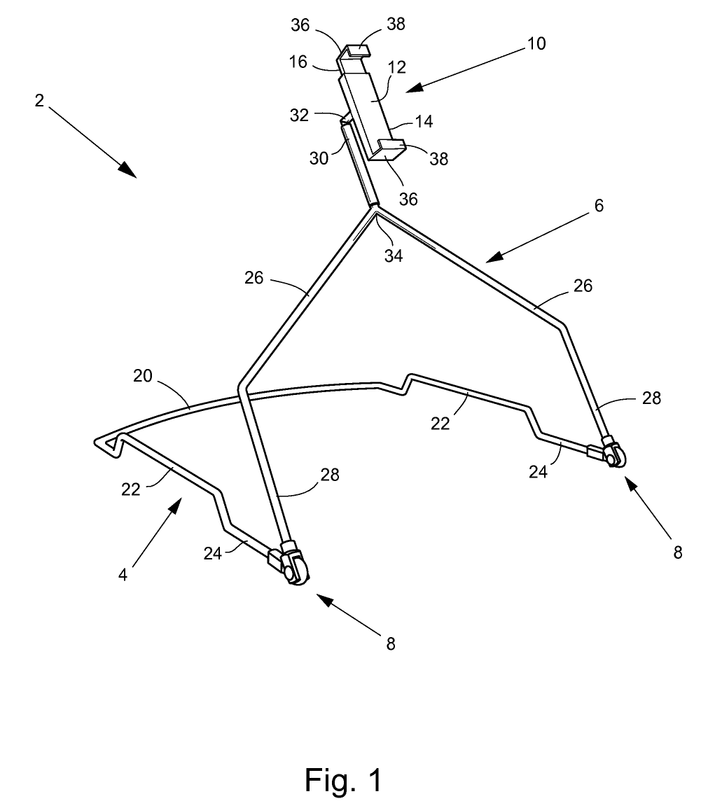

According to further embodiments, the assemblies 2 herein are supported by the user through the use of a yoke 4 configured to wrap around a user's neck area and couple to a frame 6. Preferably the yoke 4 includes a backing 20 that is U-shape, substantially so, or otherwise configured to conform around the back of the user's neck. The backing 20 can include padding, such as foam, rubber, or gel to make for a more comfortable fit, or to prevent slippage. According to highly preferred embodiments, in addition to being conformed to fit around a user's neck area, the yoke 4 can also function as a base when the assembly is used as a free-standing support (FIG. 1) instead of a user-based support (FIGS. 2-3). In other non-preferred embodiments, the yoke 4 is only configured to fit around a user's neck, and not act as a free-standing base. In still other non-preferred embodiments, the assembly is not configured to wrap around a user's neck, but is instead configured to act as a base for a free-standing support. One example of these embodiments could include a solid, non-framed base, having no openings for a user's neck.

The backing 20 of the yoke 4 can diverge into first and second arms 24 that in turn connect to first and second frame members 28 of the frame 6, preferably at their respective joints 8. The arms 24 can be parallel, converging or diverging, for example. The arms 24 can also either be level, or substantially so, or include raised sections 22 along their length. The raised sections 22 can eliminate undesirable pressure on the user's body, according to certain embodiments.

The joints 8 are configured to couple the yoke 4 to the frame 6. While not depicted in FIG. 3, preferably when in a user-based configuration, the joints 8 are preferably adapted to contact the user's chest area when in use. When in a free-standing configuration, as depicted in FIG. 1, the joints 8 will preferably contact a solid surface area, such as a table top, desk, counter, or fold-down tray of a plane or train seat, for example. As the joints 8 define a contact area, they can include padding, such as foam, rubber, or gel to make for a more comfortable fit, or to prevent slippage. While the joints 8 can be constructed at a non-adjustable, defined angle, according to preferred embodiments, the joints 8 include means for adjusting the angle between the yoke 4 and the frame 6. Means for adjusting the angle can be configured to allow for incremental or continuous adjustment.

Means for tightening, securing, and adjusting the joints 8 between the arms 24 and the frame members 28 can include: bolts, pins, nuts, and/or eyelets, for example. Means for adjusting the angle between the yoke 4 and the frame 6 can include the frame members 28 having bi-furcated ends configured to receive the ends of the arms 24 wherein both the frame member ends and the ends of the arms have aligning eyelets configured to receive a securing member that can facilitate tightening and loosening of the joint 8, such as a bolt or a pin, for example. In other embodiments, this configuration can be reversed such that the ends of the arms 24 are bifurcated and configured to receive the non-bifurcated ends of the frame members 28.

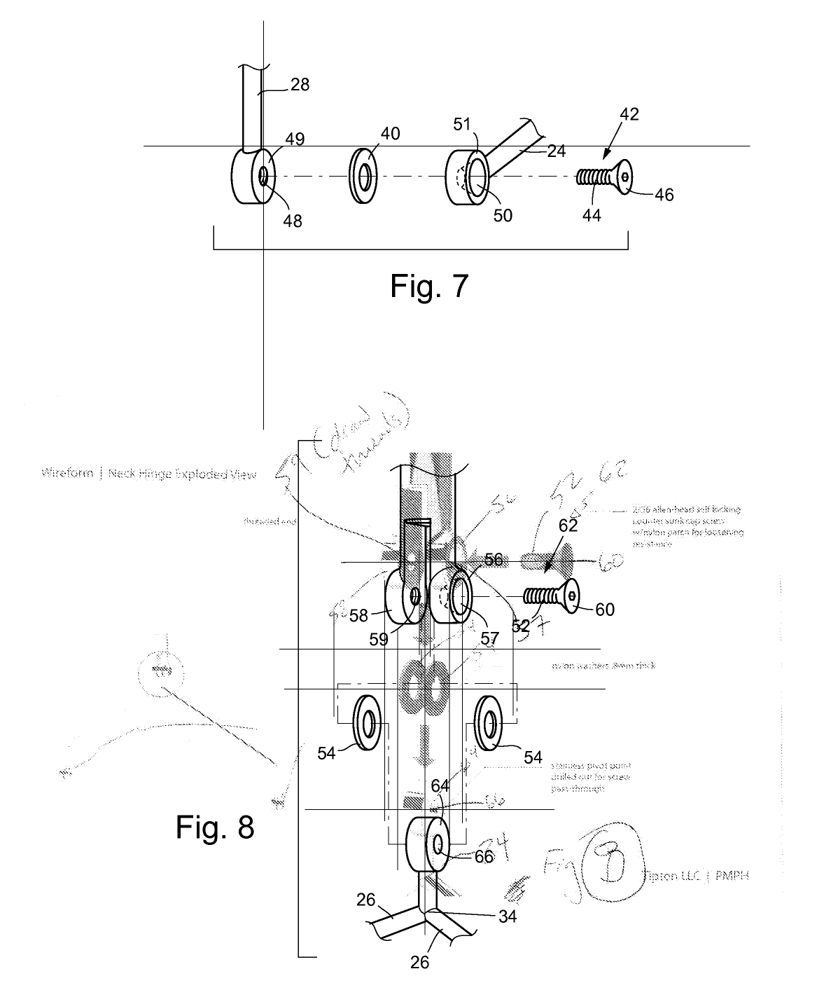

Preferred means for adjusting the angle between the yoke 4 and the frame 6 are depicted in FIG. 7. As shown in FIG. 7, a securing member, such as a screw 42 having threads 44 and a head 46 is configured to pass through a non-threaded, tapered, eyelet 50 positioned at the end 51 of an arm 24 and to then be secured in a threaded eyelet 48 at the end 49 of a frame member 28. A washer 40 can also be positioned between the end 51 of the arm 24 and the end 49 of the frame member 28, such that the screw 42 additionally passes through the washer 40. The eyelets 48 and 50 can also be configured to receive other securing members, such as a variety of bolts and pins that can facilitate tightening and loosening the joint 8. In more specific embodiments, means for tightening the securing member can be a nut, such as a wing or dome nut, for example. More specifically, the means for tightening can be twisted to loosen the connection between the arms 24 and frame members 28 to facilitate a new angle between the yoke 8 and the frame 6. Once the desired angle is achieved, the user can adjust the means for tightening to set the angle between the arms 24 and frame members 28. Adjustable joints are well known in the art, and those with skill in the art can readily select those adjustable joints that suitable with the teachings herein.

The desired angle between the yoke 4 and the frame 6 may be different depending upon whether the assembly 2 is in a free-standing configuration (FIG. 1) or a user-supported configuration (FIG. 2 and FIG. 3). More specifically, with respect to a free-standing configuration, the yoke 4 preferably is positioned to be in contact with the supporting surface and the frame 6 is preferably angled backwards towards the yoke 4, at a desirable angle at or between 35-85°. It is preferred that with this configuration, the cradle 10 is positioned such that the screen of the secured PMP 18 is facing away from the yoke 4. With respect to the user-supported configuration, the frame 6 is preferably angled 30-135° from the yoke 4, more preferably 45-65° and the cradle 10 is configured such that the screen of the secured PMP 18 is facing towards the yoke 4. Other suitable angles and positions for both configurations can also be used.

For embodiments wherein the frame 6 is adjustable with respect to the yoke 4, it is preferred that the whole assembly 2 can be fully collapsible, for easier storage and/or transportation. According to these embodiments, the yoke 4 and frame 6 can fold towards each other into a singular plane, or substantially so. The cradle 10 can be removable also.

In still further embodiments, the assemblies herein do not have joints, but rather rely on a bendable material for the yoke and frame, such as rubber or plastic surrounding a flexible metal wire, for example.

Preferred yokes 4 and frames 6 can be constructed from the following non-exclusive list of materials: metals (e.g., aluminum, titanium, or stainless steel), hollow or solid carbon fibers, fiberglass, polymers including plastic, and combinations thereof, or other materials having similar properties. The cradle 10 is preferably made of plastic, for example. As the assemblies 2 herein are intended to allow users to wear them for extended periods of time, it is preferred that the assemblies 2 are light weight such that they do not cause discomfort to the user. According to preferred, non-exclusive embodiments, the assemblies 2 herein are intended to support a PMP 18 of approximately between 3-7 ounces, thus the yoke, frame, and cradle should have sufficient strength to support PMPs within this weight range.

The frame 6 preferably includes two parallel frame members 28 that are angled inward and away from their joints 8 into two converging sections 26. The converging sections 26 can meet at a preferred point 34 that is configured to operably couple to and support the cradle 10 through an extension member 30 such as a telescoping extension member 30a , although any suitable means of coupling the frame 6 to the cradle 10 can be used with the teaching herein.

In embodiments not depicted in the Figures, the frame members can, instead of being parallel to each other, directly converge to the cradle, the stem of the cradle, the extension member, or a cross bar coupled to the cradle. In still other embodiments, also not depicted in the Figures, the frame members can diverge from one another and angle into converging members, or connect at opposite ends of a common cross bar operably coupled to the cradle. In still other embodiments, also not depicted in the Figures, the frame members can be parallel to each other and connect to opposite ends of a common cross bar coupled to the cradle.

Preferably, the convergence point 34 is located at the base of an extension member 30 configured to couple to the cradle 10, utilizing any suitable means. According to more specific embodiments, the extension member 30 acts as a receptacle for a stem 32 that is coupled to the back of the cradle 10. According to further embodiments, the stem 32, and the connected cradle 10, can move towards and away from the frame 6 within the sleeve of the extension member 30, as shown in FIG. 5. For these embodiments, the extension member 30 can include stops

Additionally, it is advantageous that the assemblies herein include means for allowing rotation of the cradle 10 around the y-axis. For example, the stem 32 can rotate within the extension member 30 such that the cradle 10 and PMP 18 can be swiveled around the extension member's 30 y-axis, such as is shown by the rotational arrow indicated in FIG. 5. This rotation can be continuously adjustable to any desired degree or incrementally adjustable such as every 30°, 45°, 90°, or 180°, for example. Said means are preferably configured to allow the screen of the PMP 18 to either directly face the yoke 4 (e.g., FIG. 1) or directly face away from the yoke 4 (e.g., FIG. 2). Means for adjusting the rotation of the cradle 10 around the extension member 30 are preferably located in the extension member 30, at the convergence point 34, or other suitable locations on the frame 6 or cradle 10. Preferred means include a bolt that can be screwed to be tightened against the stem 32 or loosened for rotation of the stem 32 within a hollowed section of the extension member 30 for example. Said means can come into contact with stem 32 trough a hole in the extension member 30. Preferred means can be adjusted by the user's hands without the use of tools (e.g., screwdrivers, wrenches) such as with the use of a wing or dome nut. Other non-preferred means can be configured to be adjusted using tools such as screwdrivers and wrenches, for example. Any suitable detent can for be used for stopping the rotation of the stem 32 around the extension member 30. The above-described means can be the same or different from the means for allowing the stem 32 to slide towards and away from the frame 6 within the sleeve of the extension member 30, as shown in FIG. 5.

In further preferred embodiments and as depicted in FIG. 6, the cradle 10 is rotatable around the z-axis of the extension member 30 and/or stem 32 such as shown in FIG. 6. The rotation can be continuously adjustable to any desired degree or incrementally adjustable such as every 30°, 45°, or 90°, for example. Means for adjusting the rotation of the cradle 10 and attached PMP 18 around the extension member's 30 z-axis preferably located in the stem 32 or at the back of the cradle 10. Preferred means include a bolt that can be screwed to be tightened against the back of the cradle 10 or loosened for rotation of the cradle 10, for example. Preferred means can be adjusted by the user's hands without the use of tools (e.g., screwdrivers, wrenches) such as with the use of a wing or dome nut. Other non-preferred means can be configured to be adjusted using tools such as screwdrivers and wrenches, for example. Other means can include one or more: spindles, axles, and/or wheels attached to the back of the cradle 10 and/or the stem 32. Any suitable detent can be used to arrest the rotation of the one or more spindles, axles, or wheels to a desired configuration. Preferably the detent allows for incremental rotation of 90 or 180 degrees. This embodiment is of particular advantage as it allows a user to view the PMP 18 in either a landscape or portrait orientation, or other desirable orientations.

The assemblies 2 herein preferably include a cradle 10 configured to hold the PMP 18 and connect to the frame 6. In certain embodiments, the cradle 10 includes means for releasably securing the PMP 18. Means for releasably securing the PMP 18 can include a backing 12 and first and second clamping members 14 and 16 configured to compress the sides or perimeter of the PMP 18 with sufficient pressure to securely hold the PMP 18. While the clamping members 14 and 16 can be of a defined configuration to accommodate a particular sized PMP 18, according to certain embodiments, one or more of the clamping members 14 and 16 are adjustable, such that can expand and contract with respect to each other. The adjustability of the clamping members 14 and 16 allows for the cradle 10 to accommodate different sized PMPs.

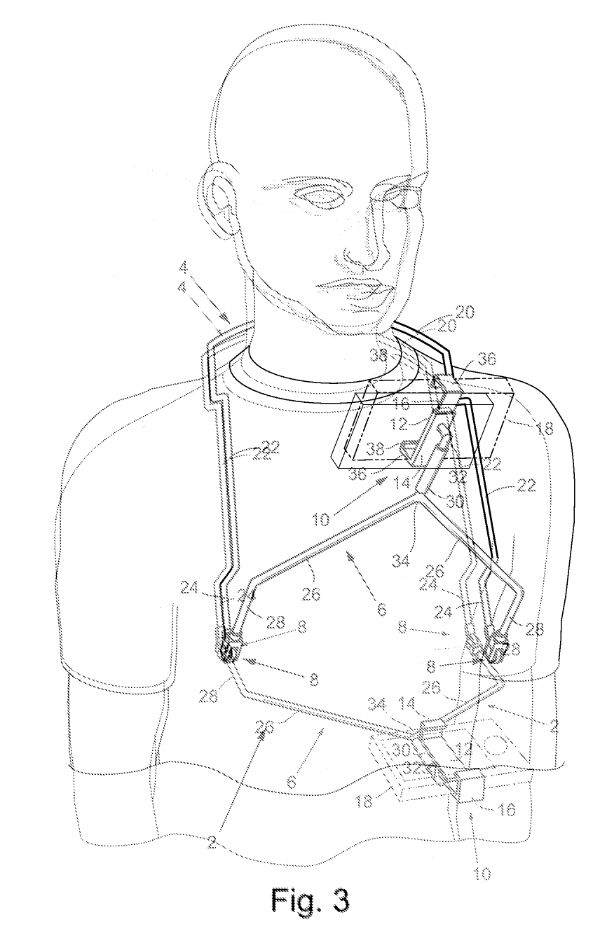

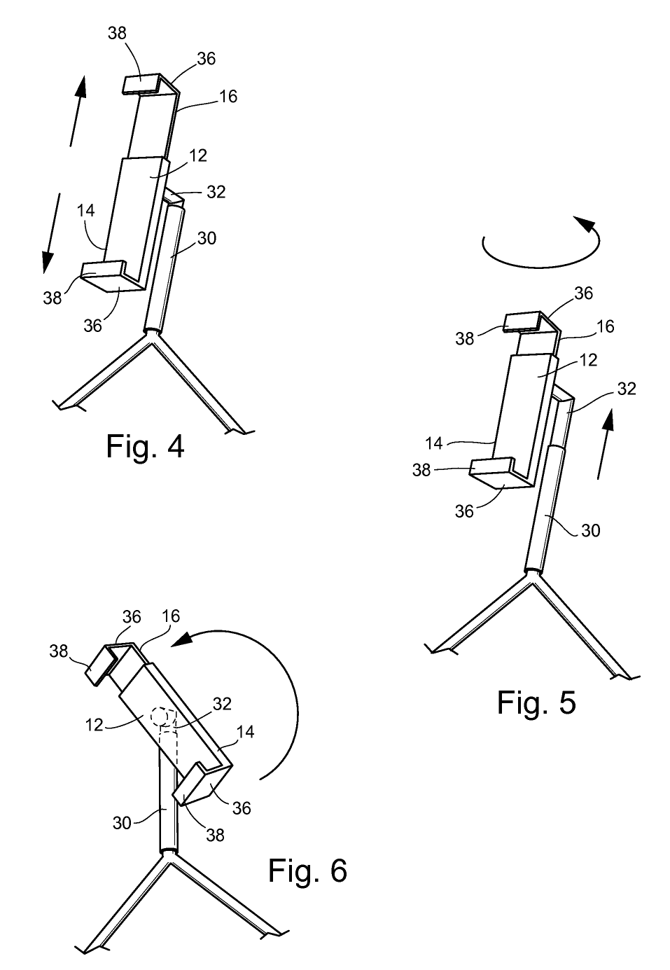

In certain embodiments the first clamping member 14 can include a sleeve configured to receive the second clamping member 16. For example, with respect to FIG. 4, the second clamping member 16 can move towards and away from the first clamping member 14 by moving in the appropriate direction within the sleeve of first clamping member 14. According to this embodiment, the body of the first clamping member 14 acts as the backing 12 for the cradle 10. According to other embodiments, the backing 12 can be separate from the first and second clamping members 14 and 16. According to more specific embodiments, the cradle's backing 12 can include an internal sleeve configured to receive either the first or second clamping member, or both, such that the respective clamping member(s) can adjustably slide up and down, thereby accommodating different sized PMPs 18.

The clamping members 14 and 16 can be as shown in FIGS. 1-6 where they include both a flange 36 and a perpendicularly attached lip 38/ or in other configurations suitable to releasably secure a PMP 18. Other non-exclusive configurations of the clamping members can include flange with a curved lip, or a flange without the lip, including either a quadrilateral or curved flange, for example. Clamping members 14 and 16 can also include non-slip or textured materials to ensure a stronger hold on the PMP 18 or to prevent damage to the PMP's 18 sides, such as plastic or rubber grips.

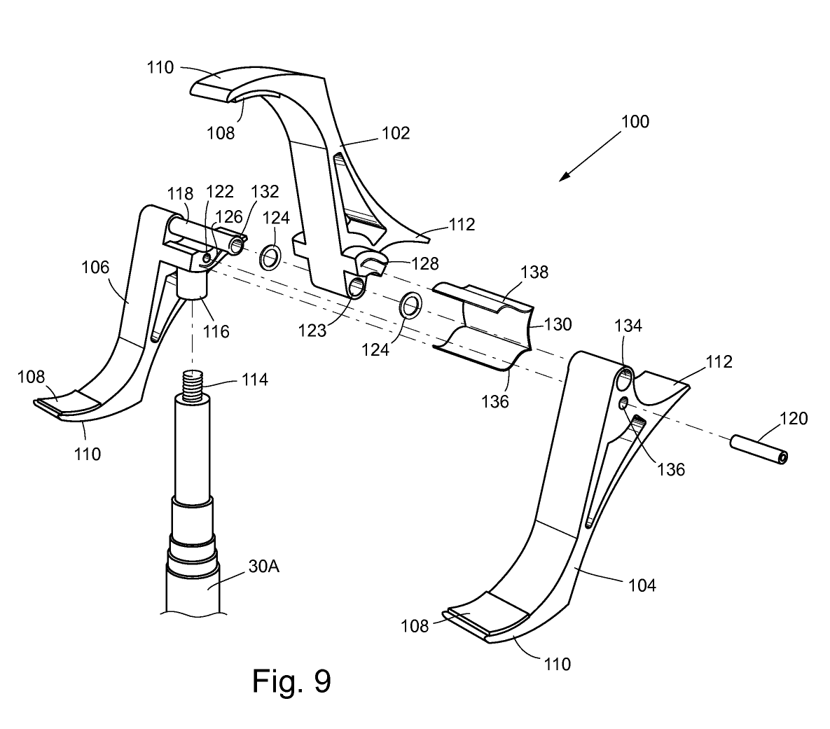

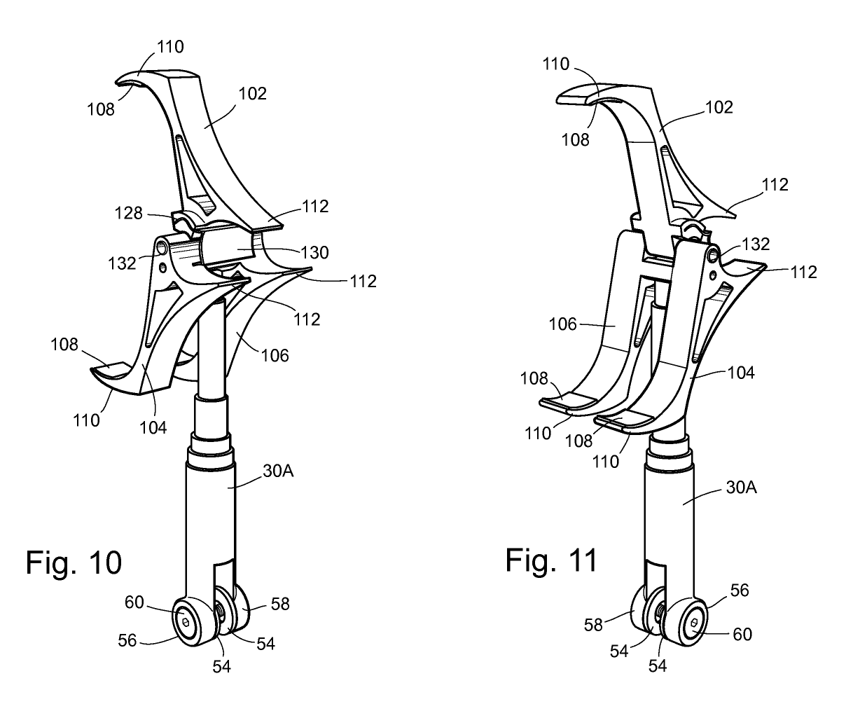

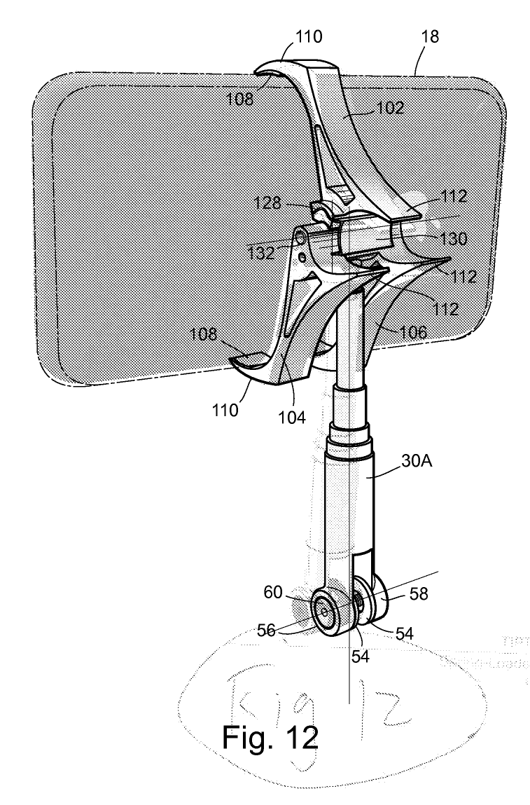

One preferred example of a cradle and its clamping members is a three clamping member cradle 100 which is provided in FIGS. 10-12. Means provided herein for rotating, and adjusting the cradle 10 depicted in FIGS. 1-6 and operably coupling to the frame 6 can also be used for the three-member cradle 100 depicted in FIGS. 9-12, and vice versa. Preferred cradles 100 are attached to the frame 6 by a telescoping extension member 30a that enables the cradle to move up and away from the frame 6 and down towards the frame 6. Telescoping devices are known in the art, and any suitable device can be used herein. Preferably the telescoping extension member 30a includes a locking system for the user to secure the member 30a at the desired height. Releasable locks for telescoping members are known in the art and any suitable releasable lock can be used with the teachings herein. Non-exclusive examples of such locks are disclosed in U.S. Pat. No. 5,417,511 to Warden, U.S. Pat. No. 2,546,157 to Hume, U.S. Pat. No. 3,724,885 to Becker, U.S. Pat. No. 5,011,319 to Levi et al., each of which is hereby expressly incorporated by reference in its entirety. According to other embodiments, the extension member is not telescoping and is not configured to move up and down, away from and towards the frame 6 respectively.

Preferred extension members 30 such as telescoping extension members 30a are coupled to the frame 6 as depicted in FIG. 8. More specifically the bottom portion of the extension member 30a is bifurcated into two ends 56 and 58. The first end 56 preferably includes a non-threaded, tapered, eyelet 57 horizontally aligned with a threaded eyelet 59 in the second bifurcated end 58 such that they are configured to receive an end member 64 of the frame 6 having its own eyelet 66 and that extends up and away from the convergence point 34. When aligned, each eyelet 57, 59, and 66 is preferably configured to receive the threads 52 of a single screw 62, or other connective member. Preferably the head 60 of the screw 62 includes a receptacle for tightening and loosening the screw 62 and is configured to not pass through the eyelet 57 in the first bifurcated end 56. More preferably, the head 60 of the screw 62 is configured to fit within a recessed, tapered, cavity within the first bifurcated end 56. One or more washers 54 can be used with the connection pieces described herein. Other connection means such as pins, wing nuts, and dome nuts can also be used with the teachings herein.

The upper portion of the telescoping member 30a preferably includes means for coupling to the cradle 100. As shown in FIG. 9, said means can include a threaded member 114 that is complementary to a threaded receptacle 116 on a clamping member 106, or other location on the cradle 100.

Preferred cradles 100 can include three clamping members: an upper clamping member 102 and two lower clamping members 106 and 104. This orientation can be switched or 2, 4, or 5 clamping members can be used in further embodiments. According to preferred embodiments, clamping members 102, 104, and, 106 can include gripping sections 110 configured to releasably apply sufficient pressure to hold the PMP 18. The gripping sections 110 can also include padding 108 such as foam, rubber, or gel to prevent damage to the PMP 18 and/or to prevent slippage. According to advantageous embodiments, the clamping members 102, 104, and, 106 are configured to work in cooperation with each other as a clamp.

FIG. 9 shows a preferred spring clamp 130 having upper and lower jaws, 138 and 136 configured to operably couple with the clamping members 102, 104, and 106. The spring clamp 130 can be made of any suitable material and is preferably made of spring steel.

One or more of the clamping members 102, 104, and 106 can include means for releasing the gripping sections 110 from applying pressure on the PMP 18 such as levers 112. Under a preferred configuration, a user can apply manual pressure to one or more levers 112 to open the clamping members 102, 104, and 106 from their natural position to receive a PMP 18 or release an already secured PMP 18. Preferred clamping members 102, 104, and 106 have a narrow S-shape with the gripping section 110 positioned at the opposite end from the release lever 112.

After pressure is released from the one or more levers 112 the spring 130 and coupled clamping members will return to their natural position. More specifically, the one or more upper clamping members 102 will naturally move towards the one or more lower clamping members 104 and 106 and vice versa. Preferably when in their natural position, the upper and lower clamping members will be separated from each other by a distance that is less than the height of the PMP 18 in landscape configuration.

According to preferred embodiments, the clamping members 102, 104, and 106 open and close in cooperation with one another through the use of one or more pins, coupling members, and/or springs. FIG. 9 shows a preferred embodiment for configuring the clamping members. One lower clamping member 106 can include a pivot pin 118 that acts as an axis of rotation and is configured to pass through an aperture 123 in the upper clamping member 102 and into an aperture 134 in the other lower clamping member 104. The pivot pin 118 can include means for securing itself to either the upper or lower clamping members 102 or 104 such as an outer lip or flange 132 that anchors the pivot pin 118 to the outside of the aperture of the other lower clamping member 104. In more specific embodiments, one or more washers 124 can be positioned on the body of the pivot pin 118 to separate clamping members 102, 104, 106 from each other. According to more specific embodiments, a second pin 120 can couple one or more clamping members together. According to FIG. 9, the second pin 120 is configured to go into a socket 126 of a lower clamping member 106 and into a second socket 136 in the other lower clamping member 104.

Preferably the upper clamping member 102 includes a slot 128 configured to receive the upper jaw 138 of the spring clamp 130 while a lower clamping member 106 includes a slot 126 for receiving the lower jaw 136 of the spring clamp 130. The second lower clamping member 104 can also include a similar slot or other means for receiving the lower jaw 136.

According to other embodiments, the cradle 10 can include other means besides clamping members for releasably securing the PMP 18. Other coupling means that can be used instead of clamping members, or in conjunction with clamping members, non-exclusively include: the use of a suction cup to suck onto the back of the PMP 18 or a PMP case, snaps or hook and loop fasteners such as VELCRO that are configured to connect to the back area of a PMP 18 or PMP case, straps such as elastic straps, magnets, mild adhesives, textured surfaces, and the like, for example.

Irrespective of whether the cradle 10 (including the three clamping member cradle 100) includes clamping members or not, it is preferred that the cradle 10 is configured such that it can hold a PMP 18 having a height of 4.5 inches, width of 2.4 inches, and a depth of 0.46 inches, such as an Apple iPhone and its future generations. In other preferred embodiments, the cradle is configured to hold a PMP 18 having a height of 4.3 inches, width of 2.4 inches and a depth of 0.31 inches, such as an Apple iPod Touch and its future generations. Other advantageous cradles can be configured to hold rectangular PMPs having heights between 4 to 5 inches, widths between 2 to 4 inches, and depths between 0.2-0.75 inches, or other suitable shapes and sizes of PMPs.

The invention may be embodied in other specific forms besides and beyond those described herein. The foregoing embodiments are therefore to be considered in all respects illustrative rather than limiting, and the scope of the invention is defined and limited only by the appended claims and their equivalents, rather than by the foregoing description.

1. An assembly for allowing hands-free viewing of a portable media player having a screen and comprising:
a yoke comprising a backing configured to wrap around a user's neck area and coupled to first and second arms that are adapted to individually extend away from said backing on the user's left and right side of the neck respectively;
a frame comprising means for coupling to the first and second arms of the yoke; and
a cradle coupled to and supported by said frame and comprising means for releasably holding the portable media player in a position that allows said user to view the screen.

2. The assembly of claim 1, wherein said yoke is also configured to function as a base to support said assembly on a solid surface.

3. The assembly of claim 1, wherein, said frame's means for coupling to said first and second arms of the yoke are joints configured such that the user can adjust the angle between the frame and the yoke.

4. The assembly of claim 3, wherein the joints are configured to allow the frame and yoke to collapse upon each other, or substantially so.

5. The assembly of claim 1, wherein said means for releasably holding the portable media player comprise two clamping members configured to compress the sides of a portable media player.

6. The assembly of claim 5, wherein said cradle comprises three clamping members configured to compress the sides of a portable media player.

7. The assembly of claim 5, wherein said clamping members include means for adjusting the distance from each other such that they can securely hold different sized portable media players.

8. The assembly of claim 1, wherein said cradle is coupled to the frame by an extension member.

9. The assembly of claim 8, wherein said extension member is a telescoping member.

10. The assembly of claim 8, wherein said cradle is configured to rotate around the y-axis of the extension member.

11. An assembly for allowing hands-free viewing of a portable media player having a screen and comprising:
a base configured to support said assembly and portable media player on a solid surface;
a frame comprising first and second frame members, each having back and front ends, wherein the back ends of the first and second frame members comprises means for coupling to said base; and
a cradle coupled to and supported by the front ends of the first and second frame members and comprising means for releasably holding the portable media player to allow said user to view the screen.

12. The assembly of claim 11, wherein said means for coupling to the base are joints configured such that the user can adjust the angle between the frame and the yoke.

13. The assembly of claim 11, wherein said means for releasably holding the portable media player comprise two clamping members configured to compress the sides of a portable media player.

14. The assembly of claim 13, wherein said clamping members include means for adjusting the distance from each other such that they can securely hold different sized portable media player.

15. The assembly of claim 11, wherein said cradle is coupled to the frame by an extension member.

16. The assembly of claim 15, wherein said extension member is a telescoping member.

17. An assembly for allowing hands-free viewing of a portable media player having a screen and comprising:
a yoke comprising a backing configured to wrap around a user's neck area and coupled to first and second arms that are adapted to individually extend away from said backing on the user's left and right side of the neck respectively;
a frame comprising first and second frame members, each having back and front ends, wherein the back end of the first frame member comprises means for adjustably coupling to said first arm and the back end of the second frame member comprises means for adjustably coupling to said second arm;
an extension member supported by said front ends of the frame members; and
a cradle coupled to and supported by said extension member and comprising means for releasably holding the portable media player in a plurality of positions to allow the user to view the screen.

18. The assembly of claim 17, wherein said means for holding the portable media player a plurality of positions are configured to allow for rotation of the cradle around the z-axis of the extension member.

19. The assembly of claim 17, wherein said means for holding the portable media player in a plurality of positions are configured to allow for rotation of the cradle around the y-axis of the extension member.
